(19) United States
(12) Patent Application Publication
(10) Pub. No.: US 2019/0086370 A1
(43) Pub. Date: Mar. 21, 2019

(54) STATISTICAL ANALYSIS OF CHAOTIC RESPONSE SIGNALS FOR TUBULARS

(71) Applicant: QUANTA ASSOCIATES, L.P., Houston, TX (US)

(72) Inventors: Dean M. Vieau, Traverse City, MI (US); Bruce I. Girrell, Traverse City, MI (US); Johana M. Chirinos, Traverse City, MI (US); Douglas W. Spencer, Rapid City, MI (US)

(21) Appl. No.: 15/954,275

(22) Filed: Apr. 16, 2018

Related U.S. Application Data
(60) Provisional application No. 62/559,859, filed on Sep. 18, 2017.
(60) Provisional application No. 62/598,074, filed on Dec. 13, 2017.

(51) Int. Cl. G01N 29/44; G01N 29/04

(52) U.S. Cl. CPC G01N 29/4472; G06F 17/18; G01N 29/4445; G01N 29/04

(57) ABSTRACT

A crack detecting system includes a tool movable along a conduit or structure and having at least one sensing device for sensing cracks in a wall of the conduit or structure. The system includes an exciter that excites the structure chaotically. The sensing device senses the material response from the exciter. A processor is operable to process response signals of the at least one sensing device. The processor analyzes the sensed response signals employing at least one methodology, wherein the at least one methodology includes a classical statistical methodology selected from the group consisting of standard deviation, skew, and kurtosis to detect cracks at wall of the conduit or structure.

### CROSS REFERENCE TO RELATED APPLICATIONS

The present application claims the filing benefits of U.S. provisional application Ser. No. 62/559,859, filed Sep. 18, 2017, which is hereby incorporated herein by reference in its entirety, and U.S. provisional application Ser. No. 62/598,074, Filed Dec. 13, 2017, which is hereby incorporated herein by reference in its entirety.

### FIELD OF THE INVENTION

The present invention relates generally to a method of detecting cracks in a pipeline or conduit or tubular via a tool or device that is moved along and within the pipeline or conduit or tubular (or moved along an exterior surface of a conduit or tubular or plate or beam or other structure).

### BACKGROUND OF THE INVENTION

It is known to use a sensing device to sense or determine the strength of and/or freepoints and/or stresses and/or characteristics of flaws or defects in pipes and other tubulars. Examples of such devices are described in U.S. Pat. Nos. 4,708,204; 4,766,764; 8,035,374 and/or 8,797,033.

### SUMMARY OF THE INVENTION

The present invention provides a crack detecting system that is operable to detect cracks along a conduit. The crack detecting system comprises a tool that is movable along a conduit and that has at least one sensing device for sensing cracks in a wall of the conduit. The sensing device and system of the present invention excites the structure (or tubular or conduit) chaotically and then receives and analyzes response signals employing classical statistical methods, which include standard deviation, skew, and kurtosis. Analysis of the standard deviation, skew, and kurtosis (“peakedness”) correlates to crack characteristics such as length, depth, and width. The success of the methodology is achieved by the use of a chaotic oscillator, for example, the use of a Duffing oscillator to produce the chaotic excitation pattern. This technique may be used for ultrasonic and electromagnetic sensing and the like.

Thus, the system of the present invention provides simplicity to determine crack characteristics and general location of crack/defect through usage of classical statistical analysis of response signals. Use of chaotic excitation provides clear statistical trend lines from responses compared to responses from sinusoidal/periodic or random excitation.

These and other objects, advantages, purposes and features of the present invention will become apparent upon review of the following specification in conjunction with the drawings.

### BRIEF DESCRIPTION OF THE DRAWINGS

FIG. 1 shows a cross section of a structure with a tool of the present invention disposed thereat;

FIG. 2 is a perspective view of the tool of FIG. 1;

FIG. 3 is a side elevation of the tool of FIG. 1;

FIG. 4 is a cross section of a structure with an external tool of the present invention disposed at an exterior of the structure;

FIG. 5 is a perspective view of another tool of the present invention, which is configured for downhole applications;

FIG. 6 is a graph showing standard deviation;

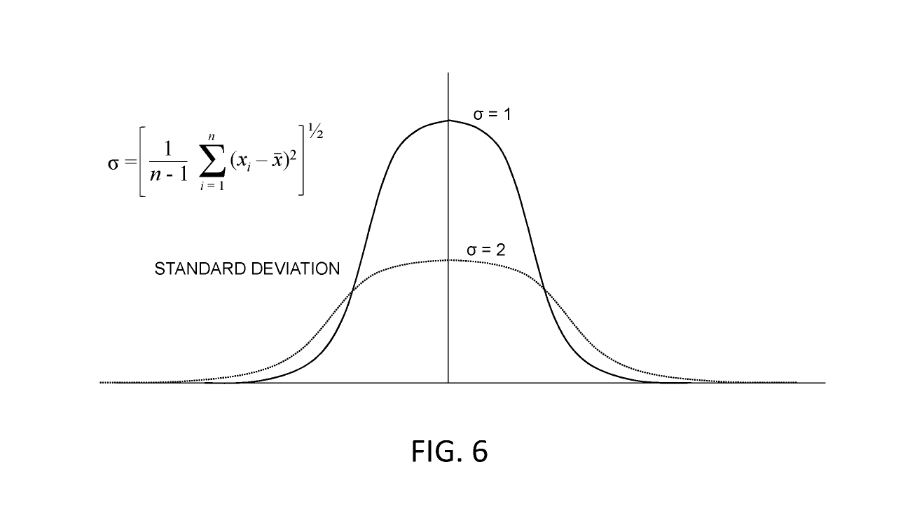

FIG. 7 is a graph showing kurtosis;

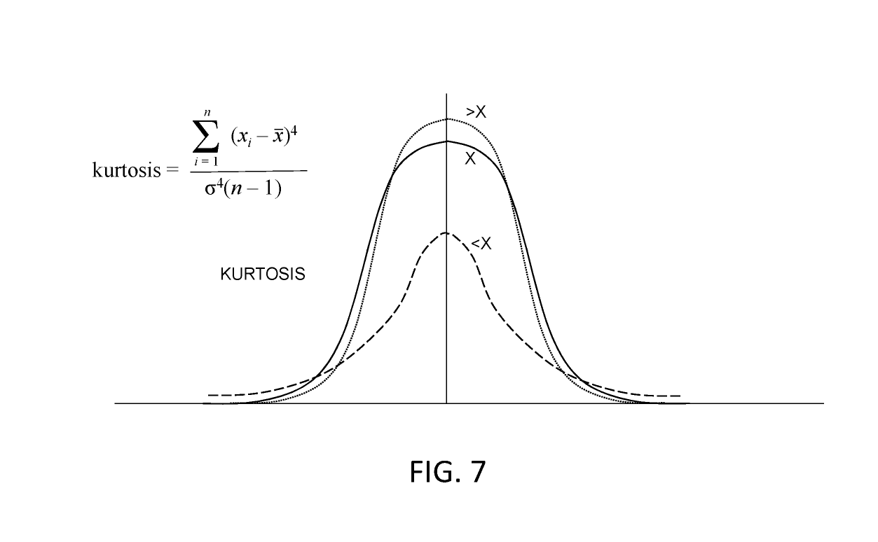

FIG. 8 is a graph showing skewness;

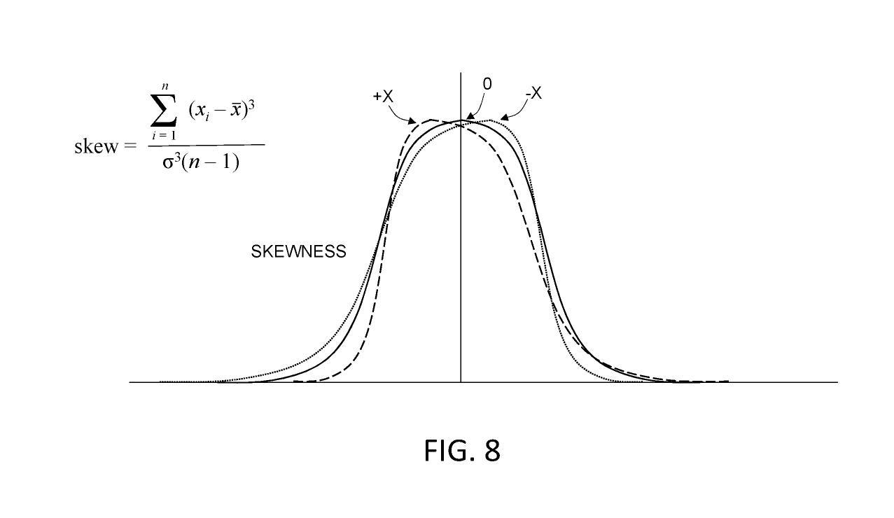

FIGS. 9A-C are graphs showing single direction statistical parameters versus crack depth ratios for the parameters of FIGS. 6-8, respectively; and

FIGS. 10A-C are graphs showing single direction statistical parameters versus normalized single dimensions for the parameters of FIGS. 6-8, respectively.

### DESCRIPTION OF THE PREFERRED EMBODIMENTS

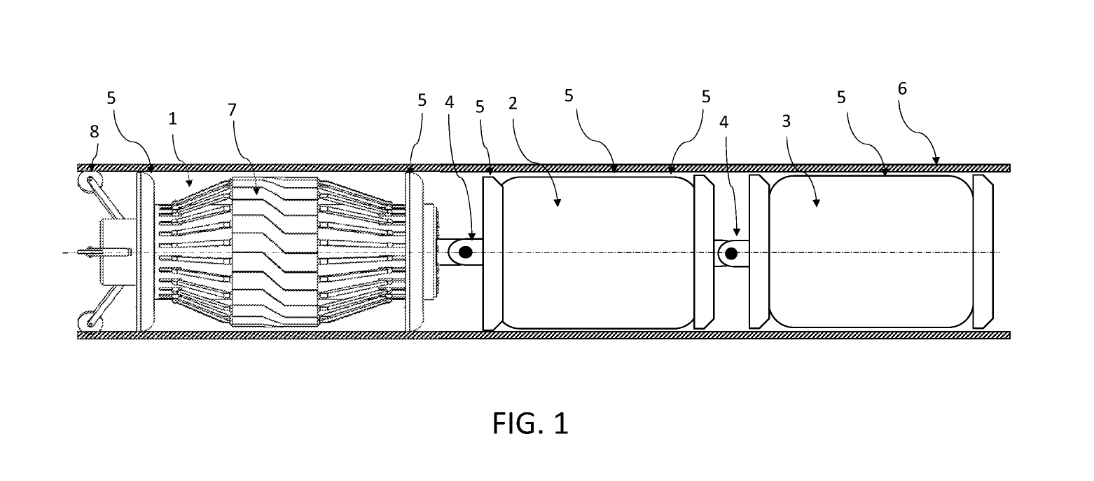

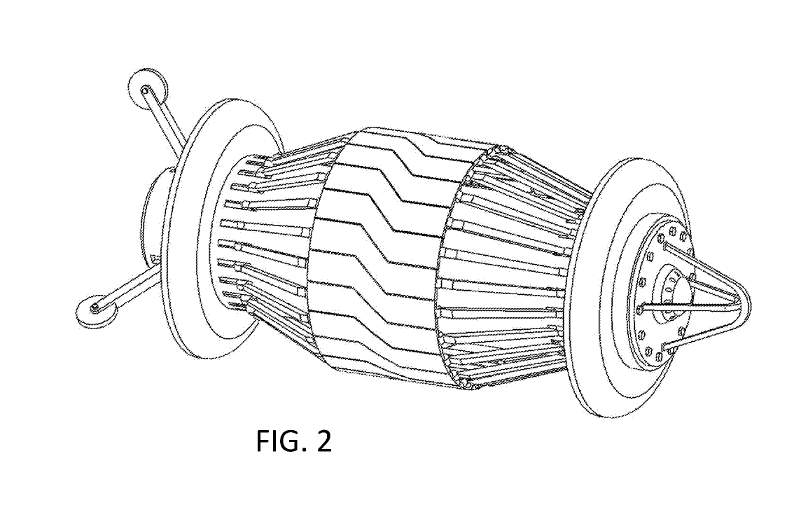

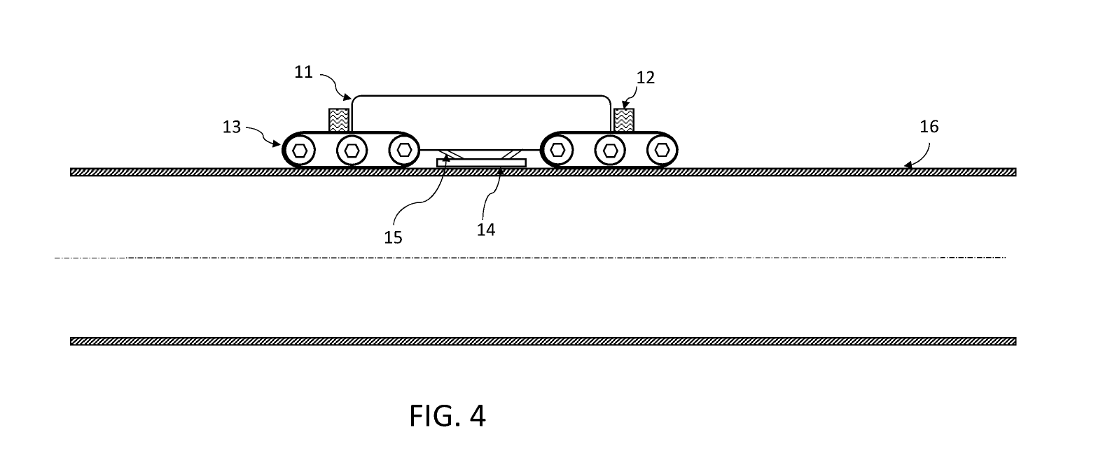

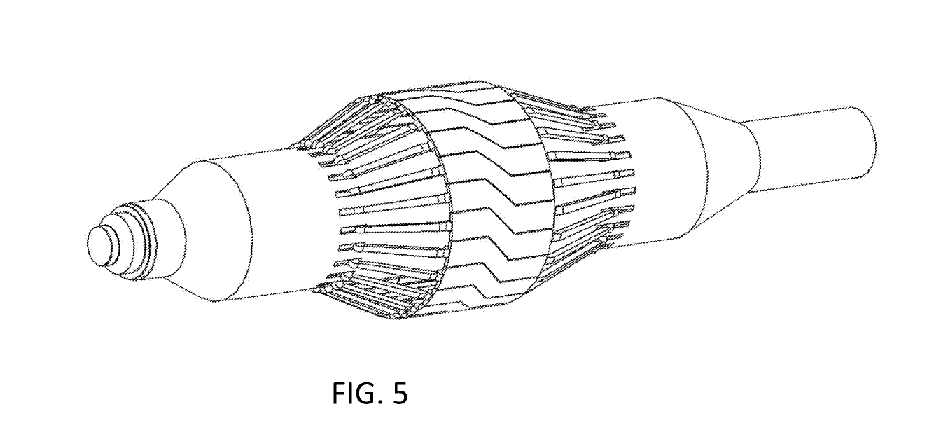

The present invention provides a system and method and apparatus for determining cracks in pipelines or well casings, and other tubulars or conduits. The tool (see, for example, FIGS. 1-3) can be operated in pipelines (such as, for example, for inline inspection), downhole applications (drill strings, well casing and tubing), and other tubulars for the purpose of stress determination in the conduit walls (such as steel or type/grade of steel or the like), or the tool may be moved along an exterior surface of a conduit or tubular or plate or beam or other structure (see FIG. 4). Optionally, and such as shown in FIG. 5, a tool of the present invention may be configured for downhole applications.

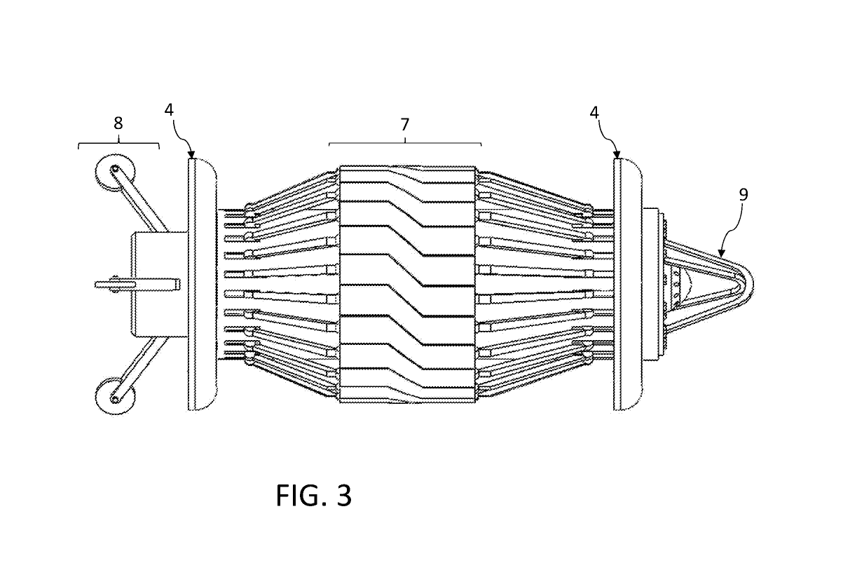

As shown in FIG. 1, the sensing module 1 is disposed in a tubular 6 and may be attached to other sensing or data collecting modules 2, 3 or the like, such as via universal joints 4. In the illustrated embodiment, the sensing module is movable through and along the tubular via drive cups 4 (and/or a centralizer and/or a cleaning ring). The sensing module includes sensor shoes 7 and one or more odometers/encoders 8. Optionally, the sensor module may include a pull/tow loop or loops 9 at its front end (such as shown in FIG. 3).

Optionally, and such as shown in FIG. 4, a tool module or apparatus 11 may be disposed at an exterior part of the structure or tubular 16. In the illustrated embodiment, the tool module 11 includes a transverse drive 12 and an axial drive 13 that are operable to move the tool along and around the structure or tubular or conduit. The tool module 11 includes a sensing device 14 attached to a body of the module via sensing device arms 15, such that the sensing device is at or near or in contact with the outer surface of the structure to sense or detect cracks in the structure wall as the module is moved along and/or around the structure.

The system of the present invention thus includes a tool or module, such as an in-line inspection (ILI) tool/module or an externally mounted and/or traveled tool/module. The power supply for the tool may be onboard the tool or power may be received from an external source. The tool includes at least one transducer acting as an exciter, which also may act as a receiver for response signals, and includes at least one transducer acting as a receiver (with or without the exciter transducer receiving). The transducer(s) is/are air-coupled or in direct contact, or any combination thereof, with the structure or material under test. Optionally, at least one transducer may act as an exciter and a receiver.

The system includes a signal generator that utilizes a chaotic oscillator, such as the Duffing oscillator (\ddot{x}+δ\dot{x}+βx+αx³=γ cos ωt, δ≥0), and at least one data storage device, and at least one data processing device. The tool includes at least one data transmission means. Optionally, the system may include a workstation for an operator to monitor the data collection and results.

A chaotic system is generally defined as a nonlinear system with only one Lyapunov exponent. A hyperchaotic system is generally defined as a chaotic system with more than one positive Lyapunov exponent. Thus, the hyperchaotic attractor is deployed in several directions contrary to the chaotic attractor, which deploys in only one direction. It is to be understood that the use of the terms “chaos” or “chaotic” in the present invention are to be interpreted as encompassing both chaotic and hyperchaotic systems.

During operation, the tool is conveyed into (or externally mounted (statically) or dynamically mobile (moveable around and/or along)) a tubular. The tool utilizes at least one transducer as an exciter, with at least one transducer as a receiver. The signal generator produces a chaotic excitation signal.

The exciter transducer receives a signal from the signal generator—the signal being a chaotic excitation pattern, such as a Duffing oscillator, a van der Pol oscillator, or the like. Response signals as a result of excitations of periodic or random waves produce defect related responses that are very complex and difficult to interpret. A chaotic excitation pattern is preferred to produce outcomes that demonstrate very predictable patterns when deciphering crack depth and crack location, which is counterintuitive.

Alternatively, the signal may be a chaotic excitation pattern from a source using exactly solvable chaos (ESC). ESC methods are composed of signal time series patterns of exactly known patterns implemented by way of lower dimensional, well defined chaotic mathematical equations. Being “exactly solvable” makes it possible to greatly simplify both the optimal signal emission of energy, as well as the optimal signal decoding of resultant return received signals, despite concurrent noise and other related clutter contaminating the desired signal.

Use of ESC may make the system more effective in detecting anomalous response signal patterns using the statistical analysis method of skew, kurtosis, and standard deviation, when the response signal to noise ratio is very poor.

Further, use of an exactly solvable chaotic source may allow weak signals to more effectively be detected among other noise related signals because the time progression of the ESC time series is known a priori.

The ESC source emission is initiated with a specific initial condition parameter (this is a unique ‘key’ that ‘primes’ the mathematically provable, and predictable, chaotic time series progression). Having control of the initial conditions of the exactly solvable chaotic time series progression of the excitation pattern simplifies the detection of the chaotic responses signal by virtue of reducing the complexity of designing an associated perfectly matched filter.

Such a matched filter makes it possible to extract very weak ESC response signals from the noise. This weak signal extraction capability makes the statistical parameter analysis related to skew, kurtosis, and standard deviation more effective in detecting material anomalies in particular when the response signals are very weak as compared to the noise levels.

As the tool is moved along the structure or tubular, the exciter transmits the chaotic excitation signal into the tubular wall, and the response signal is received by a receiving transducer. The received response signal is then recorded on a data storage device within the tool, and/or transmitted via various data transmission means to an external storage device and/or workstation. The data is then extracted from data storage and processed via a data processing device. The data processing device evaluates the recorded response signal (or optionally may process and evaluate the response signal in real-time).

The at least one data processing device utilizes classical statistical analysis techniques such as standard deviation, skew, and kurtosis (“peakedness”) that correlates to crack/defect characteristics such as location, length, depth, and width.

$$σ = {[ \frac{1}{n - 1} {\sum }_{i = 1}^{n} {( {x}_{i} - \overline{x} )}^{2} ]}^{\frac{1}{2}}$$

$$Standard Deviation ( see FIG . 6 )$$

$$kurtosis = \frac{{\sum }_{i = 1}^{n} {( {x}_{i} - \overline{x} )}^{4}}{{σ}^{4} ( n - 1 )}$$

$$Kurtosis ( see FIG . 7 )$$

$$skew = \frac{{\sum }_{i = 1}^{n} {( {x}_{i} - \overline{x} )}^{3}}{{σ}^{3} ( n - 1 )}$$

$$Skew ( see FIG . 8 )$$

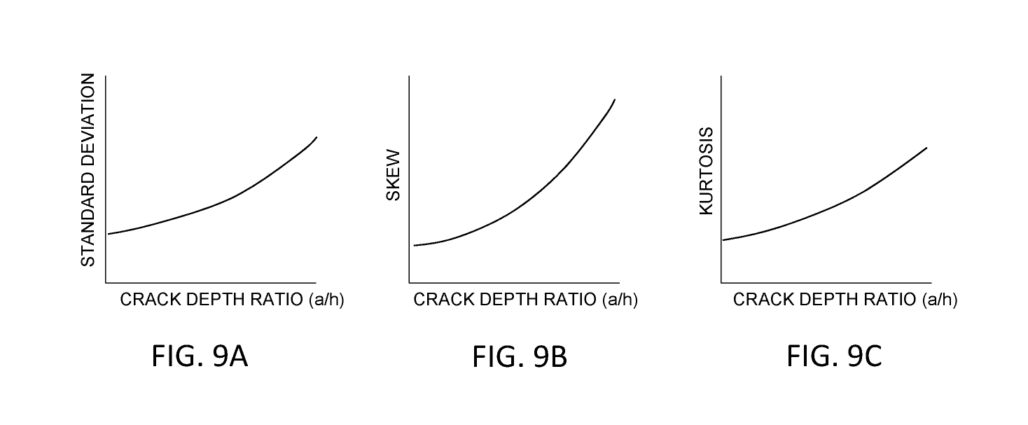

For ease of observation, standard deviation, kurtosis, and skew can be graphed or plotted (X-Y) versus the crack depth ratio (a/h=crack depth/material thickness). Such graphs or plots are shown, for example, in FIGS. 9A-C for standard deviation, skew and kurtosis, respectively.

Skew, kurtosis, and standard deviation determine crack depth when solving for “a” from known or estimated material thickness and known or estimated tubular parameters such as stiffness. Skew, kurtosis, and standard deviation demonstrate an increasing trend with increasing crack depth. Each of the statistical parameters (skew, kurtosis, and standard deviation) reveals crack depth information independent of one another, and thus, each individual test parameter can be used to corroborate the other parameters.

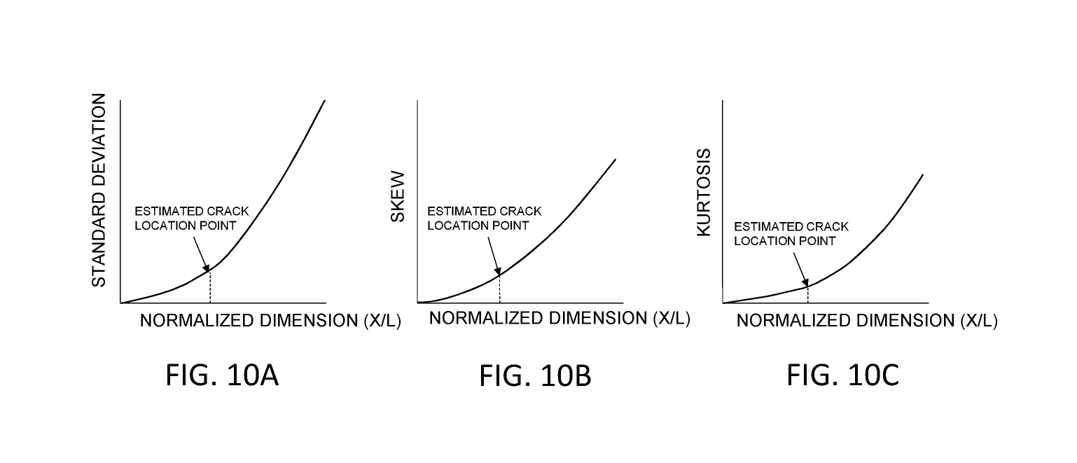

Standard deviation and kurtosis (as well as skew to a lesser degree) plots display trends that can be used to predict crack location. For example, normalized discrete dimensions/directions (such as axial, radial, transverse, etc.) versus each statistical parameter (such as shown in FIGS. 10A-C) are statistically analyzed to determine where the plot or parameter sharply or noticeably or markedly changes. Each parameter (kurtosis, standard deviation, and skew) sharply or noticeably or markedly changes at the location of the crack (dimension percentage of the entire dimension distance). At the approximate point of the change is where the estimated crack location is (see FIGS. 10A-C).

The analysis results may be displayed via any suitable means, such as via a graphical user interface (GUI) interactive interface at the workstation, or via other means such as software (such as an app) on a remote computer, tablet, smartphone, or the like.

The tool may be self-propelled (such as, but not limited to a robotic crawler such as shown in FIG. 4), or may be propelled by a gaseous or liquid medium pressure differential, or may be propelled via a cable in tension, or may be propelled via a coiled tube in compression, or a combination of the aforementioned propulsion means.

The tool may be powered on-board, remotely, or a combination of both. The tool may have a system and method to clean surfaces for better sensing abilities, and that system may be incorporated with at least one module if utilized in the tool.

The tool may be operated in tubulars with a wide variety of diameters or cross-sectional areas. Optionally, the tool may be attached to other tools (such as, for example, material identification, magnetic flux leakage, calipers, etc.). The tool may simultaneously use the aforementioned sensing technology with existing tools' sensing capabilities and/or system(s)—(such as, for example, crack detection system(s) utilize other tool capabilities simultaneously through shared componentry, magnetic fields, perturbation energy, waves, etc.).

The tool may include the means to determine position/location/distance such as, but not limited to, global positioning system(s), gyroscopic systems, encoders or odometers, etc. The tool may include the means to determine position, location or distance that stores this data on-board or transmits it to a remote location, or a combination of both. The tool may combine the position, location or distance data simultaneously with sensing data collection at any discrete location within the tubular, or on a structure's surface.

The tool may be configured to be conveyed within a borehole to evaluate a tubular within the borehole. The tool may further include a conveyance device configured to convey the tool into the borehole. The tool may be configured to be conveyed into and within the borehole via wireline, tubing (tubing conveyed), crawlers, robotic apparatuses, and/or other means.

Therefore, the present invention provides a tool or device that utilizes a sensing system or device or means to sense and collect data pertaining to cracks in the pipe or conduit or other structures in or on which the tool is disposed. The collected data is processed and analyzed to determine the cracks in the pipe or structure at various locations along the conduit or pipeline or structure.

Changes and modifications to the specifically described embodiments may be carried out without departing from the principles of the present invention, which is intended to be limited only by the scope of the appended claims as interpreted according to the principles of patent law including the doctrine of equivalents.

1. A crack detecting system operable to detect cracks along a conduit or structure, said crack detecting system comprising:
a tool movable along a conduit or structure and having an exciter and at least one sensing device for sensing cracks in a wall of the conduit or structure;
wherein said exciter excites the structure chaotically and wherein said sensing device senses response signals from the conduit or structure triggered by the exciter;
a processor operable to process the sensed response signals sensed by said at least one sensing device employing at least one methodology, and wherein the at least one methodology comprises a classical statistical methodology selected from the group consisting of standard deviation, skew, and kurtosis; and
wherein, responsive to analyzing at least one statistical parameter determined by processing the sensed response signals employing the at least one methodology, said processor detects cracks at the wall of the conduit or structure.

2. The crack detecting system of claim 1, wherein the at least one methodology comprises at least two of the classical statistical methodologies.

3. The crack detecting system of claim 1, wherein the at least one methodology comprises all three of the classical statistical methodologies.

4. The crack detecting system of claim 1, wherein the crack is detected by processing the sensed response signals to determine a threshold change in a plot of the at least one statistical parameter determined by processing the sensed response signals employing the respective methodology versus normalized dimensions.

5. The crack detecting system of claim 1, wherein said processor, responsive to analyzing at least one statistical parameter determined by processing the sensed response signals employing the at least one methodology, determines at least one characteristic of a detected crack, and wherein the determined characteristic comprises a location of the detected crack, a length of the detected crack, a depth of the detected crack, and/or a width of the detected crack.

6. The crack detecting system of claim 1, wherein said crack detecting system comprises a chaotic oscillator.

7. The crack detecting system of claim 1, wherein the response signals are sensed by a receiving transducer of said sensing device of said tool.

8. The crack detecting system of claim 1, wherein the sensed response signals are one of (i) recorded on a data storage device within the tool and (ii) transmitted via a data transmission device of said tool and recorded on an external storage device.

9. The crack detecting system of claim 1, wherein said processor, responsive to analyzing at least one statistical parameter determined by processing the sensed response signals employing the at least one methodology, detects cracks at an interior surface of the conduit or structure.

10. The crack detecting system of claim 1, wherein said processor, responsive to analyzing at least one statistical parameter determined by processing the sensed response signals employing the at least one methodology, detects cracks at an exterior surface of the conduit or structure.

11. A method for detecting cracks along a conduit or structure, the method comprising:
providing a tool comprising an exciter and at least one sensing device for sensing cracks in a wall of the conduit or structure;
moving the tool along the conduit or structure;
exciting, with the exciter, the conduit or structure chaotically as the tool moves along the conduit or structure;
sensing, with the sensing device, response signals from the conduit or structure triggered by the exciter;
analyzing the sensed response signals employing at least one methodology, and wherein the at least one methodology comprises a classical statistical methodology selected from the group consisting of standard deviation, skew, and kurtosis;
analyzing at least one statistical parameter based on the sensed response signals analysis; and
determining, based at least in part on the at least one statistical parameter, cracks at the wall of the conduit or structure.

12. The method of claim 11, wherein the at least one methodology comprises at least two of the classical statistical methodologies.

13. The method of claim 11, wherein the at least one methodology comprises all three of the classical statistical methodologies.

14. The method of claim 11, wherein determining cracks at the wall of the conduit or structure comprises determining a threshold change in a plot of the at least one statistical parameter.

15. The method of claim 11, wherein determining cracks at the wall of the conduit comprises determining at least one characteristic of a determined crack, and wherein the determined characteristic comprises a location of the determined crack, a length of the determined crack, a depth of the determined crack and/or a width of the determined crack.

16. The method of claim 11, wherein the tool further comprises a chaotic oscillator.

17. The method of claim 11, wherein the sensed response signals are received by a receiving transducer of the sensing device of the tool.

18. The method of claim 11, further comprising:
transmitting, via a data transmission device of the tool, the sensed response signals; and
recording, on an external storage device, the transmitted response signals.

19. The method of claim 11, wherein determining cracks at the wall of the conduit or structure comprises detecting cracks at an interior surface of the conduit or structure.

20. The method of claim 11, wherein determining cracks at the wall of the conduit or structure comprises detecting cracks at an exterior surface of the conduit or structure.

21. A crack detecting system operable to detect cracks along a conduit or structure, the crack detecting system comprising:
a tool movable along a conduit or structure and having an exciter and at least one sensing device for sensing cracks in a wall of the conduit or structure;
wherein the exciter comprises a chaotic excitation source and wherein the exciter excites the structure chaotically and wherein the sensing device senses response signals from the conduit or structure triggered by the exciter;
a processor operable to process the sensed response signals of the at least one sensing device employing at least one methodology, and wherein the at least one methodology comprises a classical statistical methodology selected from the group consisting of standard deviation, skew, and kurtosis; and
wherein, responsive to analyzing at least one statistical parameter determined by processing the sensed response signals employing the at least one methodology, the processor detects cracks at the wall of the conduit or structure.

22. The crack detecting system of claim 21, wherein the chaotic excitation source comprises an exactly solvable chaotic excitation source.

23. The crack detecting system of claim 22, wherein the exactly solvable chaotic excitation source comprises an initial condition parameter.
